(19) United States
(12) Patent Application Publication
(10) Pub. No.: US 2006/0259304 A1
(43) Pub. Date: Nov. 16, 2006

(54) A SYSTEM AND A METHOD FOR VERIFYING IDENTITY USING VOICE AND FINGERPRINT BIOMETRICS

(76) Inventor: Ziv . BARZILAY, Ramat Hasharon (IL)

Correspondence Address: EDWARD LANGER;c/o SHIBOLETH YISRAELI ROBERTS ZISMAN & CO., EMPIRE STATE BUILDING, 60TH FLOOR, 350 FIFTH AVENUE, NEW YORK, NY, 10118, US

(21) Appl. No.: 11/420,811

(22) Filed: May 30, 2006

Related U.S. Application Data
(63) Continuation-in-part of application No. 10/958,498, filed on Oct. 6, 2004, now Pat. No. 7,054,811.
(63) Continuation-in-part of application No. PCT/IL03/00388, filed on May 14, 2003.
Application No. PCT/IL03/00388 is a continuation-in-part of application No. 10/288,579, filed on Nov. 6, 2002.
(60) Provisional application No. 60/598,543, filed on Aug. 4, 2004.
(60) Provisional application No. 60/332,155, filed on Nov. 21, 2001.

(51) Int. Cl. G10L 11/00

(52) U.S. Cl. 704/273; 340/5.52; 382/124

(57) ABSTRACT

A system for verifying and enabling user access based on voice parameters and fingerprint parameters. The system includes a voice registration unit for registering a user by finding the user's voice parameters in a voice registration sample and storing same in a voice sample database to provide a substantially unique and initial identification of each of a plurality of users. The system also includes a voice authenticating unit for substantially absolute verification of an identity of one of the plurality of users. The system also includes a fingerprint registration unit for registering a user by finding the user's fingerprint parameters in a fingerprint registration sample and storing same in a fingerprint sample database to provide a substantially unique and initial identification of each of a plurality of users and a fingerprint authenticating unit for substantially absolute verification of an identity of one of the plurality of users.

### CROSS-REFERENCE TO RELATED APPLICATIONS

The present application is a continuation-in-part of U.S. patent application Ser. No. 10/958,498, filed Oct. 6, 2004, entitled “Method And System For Verifying And Enabling User Access Based On Voice Parameters,” which claims the benefit of U.S. provisional appln. 60/598,543, filed Aug. 4, 2004, having the same title; the '498 appln. is a continuation-in-part of PCT/IL03/00388 filed May 14, 2003, entitled “A System and a Method for Conducting Secure, Voice-Based, E-Commerce Transactions Over a Telecommunications Device”; which is a continuation-in-part of U.S. patent application Ser. No. 10/288,579, filed Nov. 6, 2002, entitled “System and a Method for Transacting E-commerce Utilizing Voice-recognition and Analysis”, which claims the benefit of U.S. provisional appln. 60/332,155 filed Nov. 9, 2001, having the same title; all of the aforementioned applications were filed by the inventor of the present invention, and all of said applications are incorporated herein by reference.

### FIELD OF THE INVENTION

The present invention generally relates to providing secure, biometric-based access for a range of activities and transactions, and more particularly, to a method and system for global coverage by a multi-biometric solution for registering and verifying a user's identity for secure, voice-based and finger-print based access.

### BACKGROUND OF THE INVENTION

Biometrics is defined as the automatic recognition of a person based on his/her physiological or behavioral characteristics. The desirable properties of biometrics are:
universality (found in every person)
uniqueness (different “value” for each person)
permanence (invariant with time)
collectability (quantitatively measurable)
performance (accuracy vs. resources)
high acceptability (person's willingness)
low circumvention (not easy to deceive)

Biometrics is used to control access to an area or a computer, for example, by means of such biological signatures defined by personal features such as the pattern of the iris in the person's eye, fingerprints and a voiceprint. A digital pattern of these features of the person is stored in a database and compared with the biometric signature read by some device. The signal processing aspects of voice verification, for example, are outlined in prior art FIG. 1. The main voice verification activities 110 in this general field are highlighted. Biometrics promises a higher level of security than that which can be achieved using a person's written signature, password, key or photo to identify the person and allow access. The idea isn't necessarily to do away with these forms of identification, but to raise the level of security. By using biometrics for identification, the indentity information is not lost, stolen or forgotten and maybe there will be less fraud.

The primary advantage of this method of identification is that each biometric signature is essentially unique and impossible to forge. Another advantage of such methods is that information is stored in a database, so the signature could be used anywhere by simply accessing the database. Finally, it is better than using a password or key that could be lost or stolen. The password in this case is part of the person himself.

A major disadvantage of using biometrics for identification is the cost of implementing it. Digital fingerprint readers are expensive, and generally must be added to pre-existing systems. However, the price is dropping. There is also fear from civil liberty groups that using biometrics with information stored in databases that can be easily accessed many locations may lead to abuses in personal freedom and privacy.

Among all the biometric techniques, fingerprint-based identification is the oldest method which has been successfully used in numerous applications. Everyone is known to have unique, immutable fingerprints. A fingerprint is made of a series of ridges and furrows on the surface of the finger. The uniqueness of a fingerprint can be determined by the pattern of ridges and furrows as well as the minutiae points. Minutiae points are local ridge characteristics that occur at either a ridge bifurcation or a ridge ending.

A critical step in automatic fingerprint matching is to automatically and reliably extract minutiae from the input fingerprint images. However, the performance of a minutiae extraction algorithm relies heavily on the quality of the input fingerprint images. In order to ensure that the performance of an automatic fingerprint identification/verification system will be robust with respect to the quality of the fingerprint images, it is essential to incorporate a fingerprint enhancement algorithm in the minutiae extraction module.

Advantages of fingerprint matching:
Prints remain the same throughout a person's lifetime.
Fingerprinting is neither frightening nor emotionally disturbing.
People's prints are unique.

Disadvantages of fingerprint matching:
Searching through a huge database can be rather slow
Dirt on the finger or injury can blur the print.
A fingerprint template is rather large compared to other biometric devices.

The fact that fingerprint identification files are extremely large (250 Kb) compared to other biometrics, has created a problem for installing fingerprint biometric data on portable ID cards. The users must have databases at each verification site or create a way to download data to a central site of identity verification, which increases cost and slows down the matching process.

Another identification method is voice-based. In prior art technologies, earlier attempts to deal with voice verification were focused on the content of the voice. What are the words that were being spoken? Thus, individual speakers may pronounce the letters in very similar fashion. So the letter “k” if pronounced by two different people may sound the same. If one focuses on whether the letter is a “k” or not, then one will not easily be able to determine who said that letter.

The speaker-specific characteristics of speech are due to differences in physiological and behavioral aspects of the speech production system in humans. The main physiological aspect of the human speech production system is the shape of the vocal tract. The vocal tract is generally considered as the speech production organ above the vocal folds, which consists of the following: (i) laryngeal pharynx (beneath the epiglottis), (ii) oral pharynx (behind the tongue, between the epiglottis and velum), (iii) oral cavity (forward of the velum and bounded by the lips, tongue, and palate), (iv) nasal pharynx (above the velum, rear end of nasal cavity), and (v) nasal cavity (above the palate and extending from the pharynx to the nostrils). Prior art FIG. 2 depicts the vocal tract. Some of the active vocalization elements are the soft palate 210, the hard palate 220, the lips 230, the tongue 240 and the teeth 250.

The shape of the mouth controls features of the voice, such as the tone. These parameters stay constant with the speaker, enabling a singular identification of the particular speaker

The vocal tract modifies the spectral content of an acoustic wave as it passes through it, thereby producing speech. Hence, it is common in speaker verification systems to make use of features derived only from the vocal tract. In order to characterize the features of the vocal tract, the human speech production mechanism is represented as a discrete-time system.

The acoustic wave is produced when the airflow from the lungs is carried by the trachea through the vocal folds. This source of excitation can be characterized as phonation, whispering, frication, compression, vibration, or a combination of these. Phonated excitation occurs when the airflow is modulated by the vocal folds. Whispered excitation is produced by airflow rushing through a small triangular opening between the arytenoid cartilage at the rear of the nearly closed vocal folds. Frication excitation is produced by constrictions in the vocal tract. Compression excitation results from releasing a completely closed and pressurized vocal tract. Vibration excitation is caused by air being forced through a closure other than the vocal folds, especially at the tongue. Speech produced by phonated excitation is called voiced, that produced by phonated excitation plus frication is called mixed voiced and that produced by other types of excitation is called unvoiced.

The above discussion also underlines the text-dependent nature of the vocal-tract models. Since the model is derived from the observed speech, it is dependent on the speech content.

The Performance Histogram of biometric verification is illustrated in the prior art graph of FIG. 3. The Match score on the x-axis, runs from low on the left to high on the right, and the number of cases matched shown on the y-axis. A false reject 310 is distinguished from a false accept 320. Basic errors are of Type I and Type II. There are four possible outcomes in a single trial, two of which correct and two are incorrect. The False Reject Rate (FRR) is indicative of an unhappy customer, or Type I error. The False Accept Rate (FAR) is indicative of a happy bad guy, or Type II error.

Failure to Enroll and Acquire by Voice

Fail To Enroll (FTE): a system may fail to enroll a valid user for a variety of reasons, e.g., a mute person
Fail To Acquire (FTA): System may fail to acquire signal of valid user, due to line noise or bad microphone
Total error rates should include FTA and FTE of valid users in error rates

A commercial fingerprint-based authentication system requires a very low False Reject Rate (FRR) for a given False Accept Rate (FAR). This is very difficult to achieve with any one technique.

Several US patents mention fingerprints and voice verification, but mostly in the background section as examples of biometrics. For example, U.S. Pat. No. 6,260,024, Method and Apparatus for Facilitating Buyer-driven Purchase Orders on a Commercial Network System, to Shkedy, issued Jul. 10, 2001, mentions both forms of biometrics in separate embodiments.

Therefore, although a voice verification system may be substantially accurate, outside factors may limit its applicability. Fingerprint systems may also be limited by outside factors. Thus, it would be desirable to use a combination of biometric systems to achieve accurate identification of an individual.

### SUMMARY OF THE INVENTION

Accordingly, it is a principal object of the present invention to improve the verification of users and enable users to obtain access to a wide range of activities and sites by combining the techniques of voice verification and fingerprint matching.

It is a further principal object of the present invention to provide global coverage by a complementary solution for all the people of the world.

It is another principal object of the present invention to provide, in general, highly increased accuracy by using voice and fingerprints together.

It is yet another object of the present invention to provide an improved system and method for registering and authenticating secure, voice-based, e-commerce transactions over a telecommunications device utilizing both voice verification algorithms and fingerprint matching algorithms.

It is yet a further object of the present invention to provide a system and a method for identity verification wherein some of the limitations of voice verification are overcome by simultaneous implementation of a fingerprint verification system and wherein some of the limitations of fingerprint verification are overcome by simultaneous implementation of a voice verification system.

It is yet one other object of the present invention to provide a system and a method for identity verification wherein integrated voice/fingerprint is more practical remotely, such as by telephone, using the voice verification subsystem and more practical in close proximity using the fingerprint verification subsystem.

In accordance with a preferred embodiment of the present invention, there is provided a system for verifying and enabling user access, which includes a voice registration unit for providing a substantially unique and initial identification of each of a plurality of the speaker/users by finding the speaker/user's voice parameters in a voice registration sample and storing same in a database. The system also includes a fingerprint matching system.

A system is disclosed for verifying and enabling user access based on voice parameters and fingerprint parameters. The system includes a voice registration unit for registering a user by finding the user's voice parameters in a voice registration sample and storing same in a voice sample database to provide a substantially unique and initial identification of each of a plurality of users and a voice authenticating unit for substantially absolute verification of an identity of one of the plurality of users. The voice authenticating unit includes a recognition unit for providing a voice authentication sample and being operative with said database and a decision unit operative with the recognition unit and the voice sample database to decide whether the user associated with said voice authentication sample is the same as the identity of the user registered with the system and associated with said voice registration sample.

The system also includes a fingerprint registration unit for registering a user by finding the user's fingerprint parameters in a fingerprint registration sample and storing same in a fingerprint sample database to provide a substantially unique and initial identification of each of a plurality of users and a fingerprint authenticating unit for substantially absolute verification of an identity of one of the plurality of users. The BioGard BioSafe AC02 is an exemplary commercially available RF-based fingerprint system for physical access control, available at Discount Security Store 2106 Venice Drive, So. Lake Tahoe, Calif., 96150, USA.

The fingerprint authenticating unit includes a recognition unit for providing a fingerprint authentication sample and for being operative with the fingerprint sample database and includes a decision unit operative with the recognition unit and said fingerprint sample database to decide whether the user associated with the fingerprint authentication sample is the same as the identity of the user previously registered with the system and associated with said fingerprint registration sample, such that the identity of one of said plurality of users is substantially absolutely verified for access purposes.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is a prior art flow diagram of the digital signal processing (DSP) steps used in speaker verification;

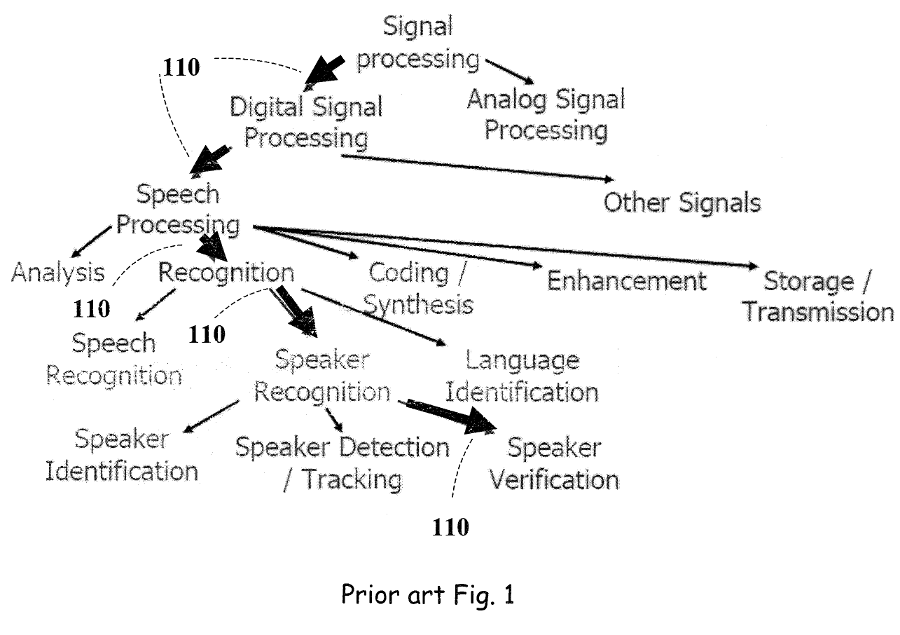

FIG. 2 is a prior art illustration of the features of the human vocal tract;

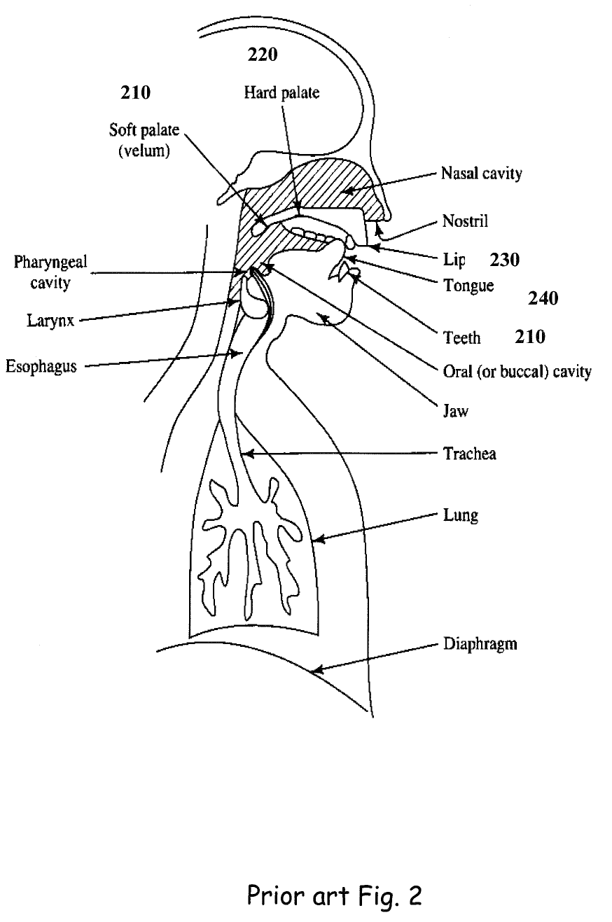

FIG. 3 is a prior art graph illustrating biometric verification;

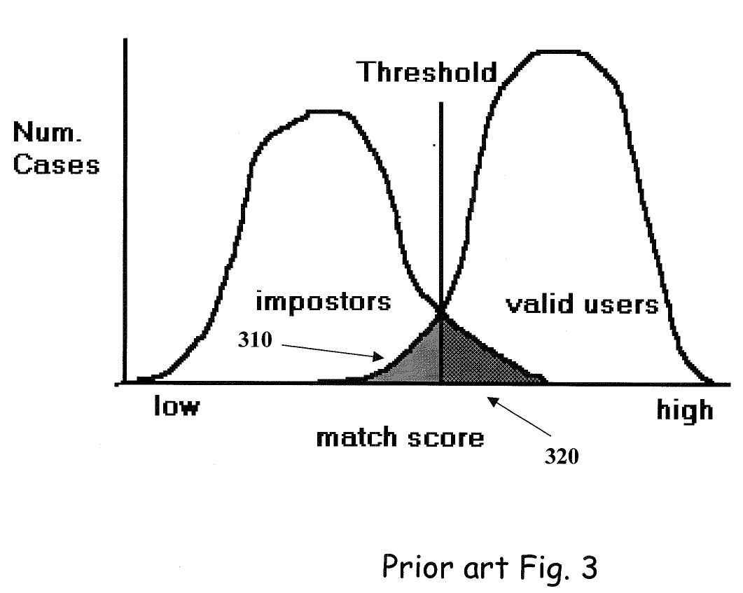

FIG. 4a is a flow diagram of the enrollment training steps used in speaker voice and fingerprint verification, performed according to the principles of the present invention;

FIG. 4b is a flow diagram of the enrollment digital speech acquisition steps used in speaker verification, performed according to the principles of the present invention;

FIG. 4c is a schematic diagram of an exemplary enrollment system used in speaker fingerprint imaging using the principle of frustrated internal reflection, constructed according to the principles of the present invention;

FIG. 4d is a flow diagram of the feature creation steps used in speaker verification, performed according to the principles of the present invention;

FIG. 5 is a art flow diagram of the voice verification steps used in speaker verification, performed according to the principles of the present invention; and

FIG. 6 is a flow chart of the steps used in combining fingerprint verification with voice verification for identity verification, performed according to the principles of the present invention.

### DETAILED DESCRIPTION OF A PREFERRED EMBODIMENT

The present invention for a multi-biometric solution has two phases of operation: (1) voice and fingerprint enrollment or registration and (2) voice authentication, also known as voice verification and fingerprint matching. A few percent of the world's population cannot use fingerprints. Also about one percent cannot speak, either permanently or temporarily. In such situations a single biometric can suffice. Thus coverage is made by the present invention for any such occurrence.

During spectrographic analysis the raw voice data and fingerprint data are investigated and generate a unique pattern, for both a voice print and a finger print. This allows extraction of geometrical characteristics relative to the speaker's voice and fingerprints. Finally, the Lyapunov exponents involve computation of a spectrum of exponents, which characterize the voice registration sample uniquely.

During voice registration the object is to find the speaker's voice parameters. Voice registration involves three major steps: fractal analysis, spectrographic analysis and determination of the Lyapunov exponents. As described in the previous application by the present inventor, forming the basis of this CIP application, U.S. Ser. No. 10/958,498, referenced above and published May 5, 2005 under publication no. US-2005-0096906-A1, feature vectors are used to make unique definitions of a person's voice. Among the feature vectors used are those related to physiological aspects of a speaker in the construction of the vocal system: the tongue, the voice, the throat, the windpipe, the ears and the shape of the mouth. The ears are included because a person modifies his speech according how he hears himself. All of these are aspects that will determine how his voice sounds. Just as a musical wind instrument makes noise based on the shape of the pipe and the reed and all of these features, the human body has physiological features related to sound creation using the voice.

These features are some of the things that make a distinction between one speaker and another, and by using the inventive technique these features can be captured as a feature vector which defines the speaker. The problem with using the voice to differentiate speakers is that one's voice changes over time, but because these physiological parameters of the body's construction do not change, and one can identify them in feature vectors, they will be repeated each time the voice sample is received.

So even the shape of the ear is useful as a parameter because this helps to understand how a person adjusts the loudness of his voice, the volume, when he hears the echo of his own voice as he speaks. This is sort of an internal feedback system, as is used in electronic systems, wherein an automatic gain control (AGC) box is used to determine the volume level. Similarly, the body automatically adjusts its voice because the person hears his own voice. For this reason deaf people, who are not able to make these adjustments, frequently do not develop their speech very well.

The invention includes a special mathematical relationship to derive these features related to the physiological aspects of the speaker. The voice analysis model in the invention breaks the voice into two major parts: a fixed portion and a variable portion. The fixed portion is related to the fixed physiological parameters of the speaker, which are identified as vectors in the algorithm. In addition, there are variable portions which change with the change in the person's voice, based on time of day, perhaps the emotional state, state of health, various things that will create changes in the way the variable portion looks in the features. The present invention examines those variable portions and learns from them as the person grows and ages over time. The voice sample is constantly updated to maintain currency.

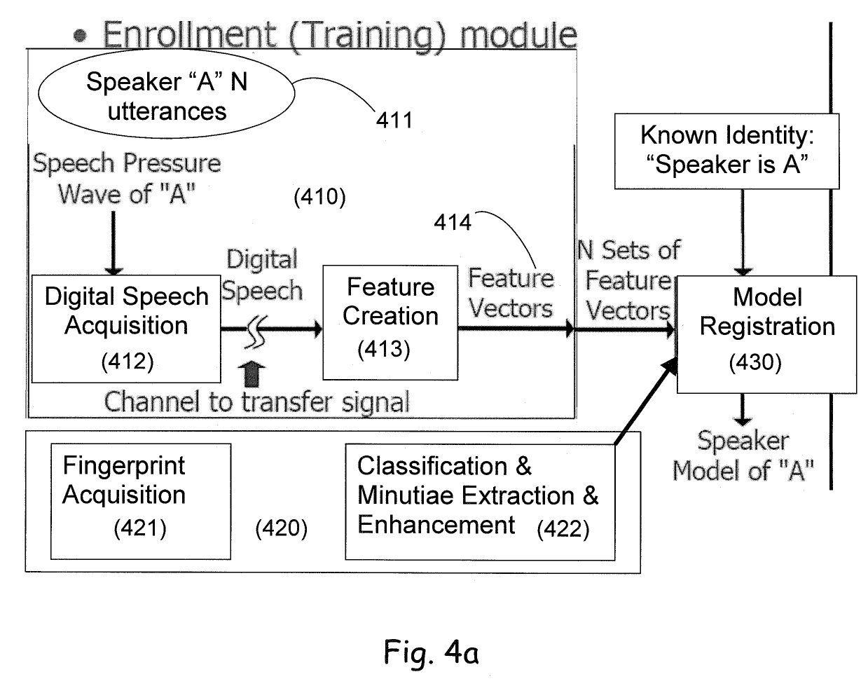

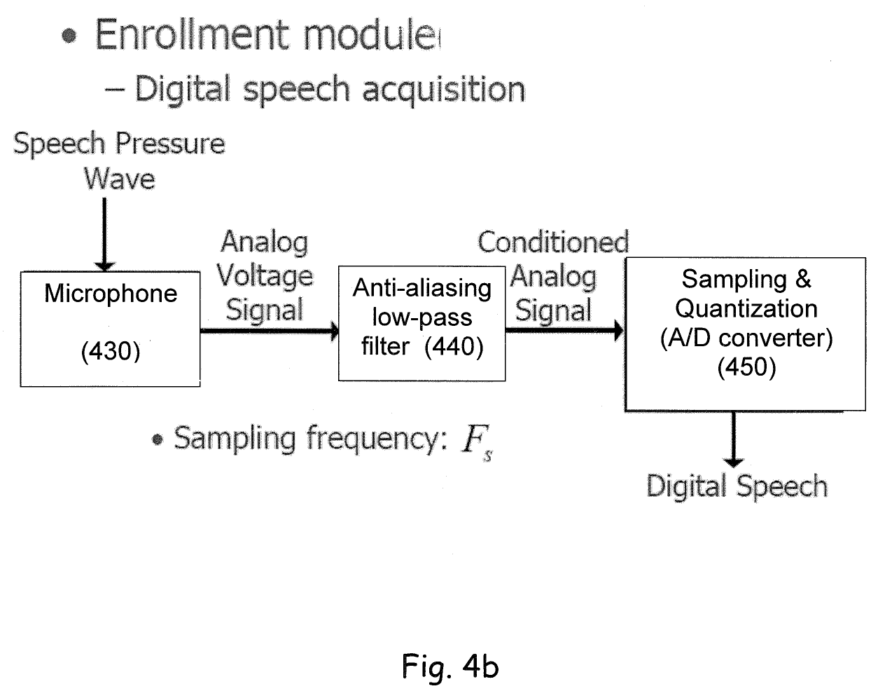

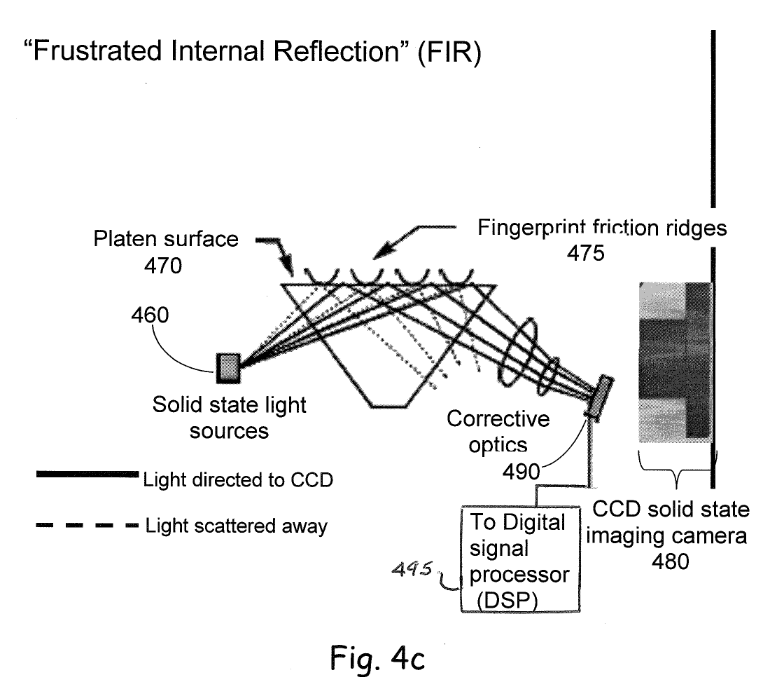

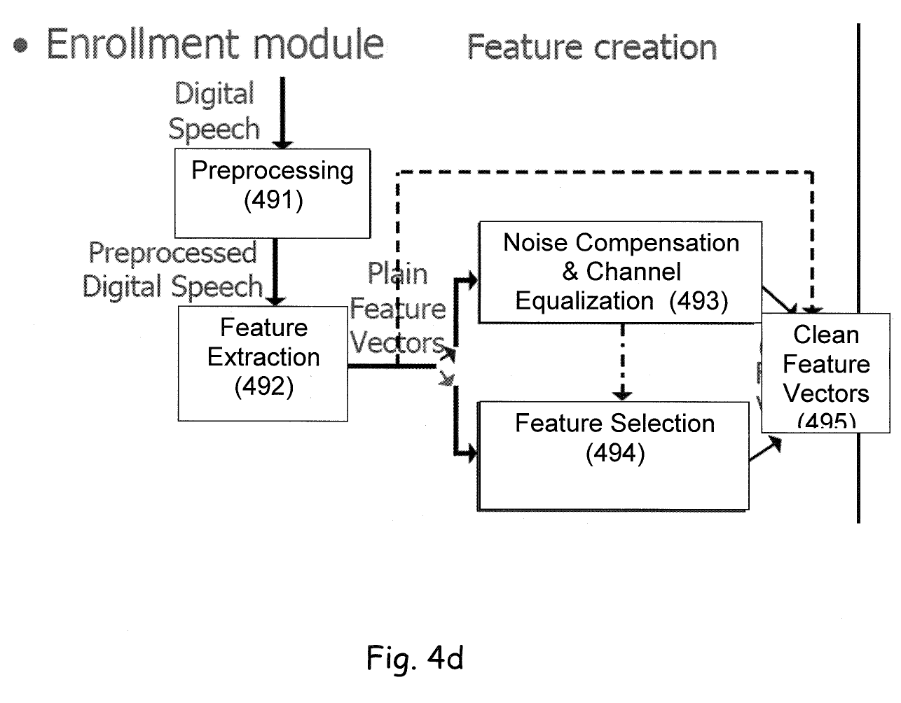

FIG. 4a is a flow diagram of the enrollment training steps used in speaker voice and fingerprint verification, performed according to the principles of the present invention. Voice enrollment of speaker “A” in enrollment module 410 begins with N utterances 411 by the speaker. After digital speech acquisition 412 and feature creation 413, the feature vectors 414 for each utterance are extracted as detailed in the above-referenced published application by the inventor of the present application. Fingerprint enrollment sub module 420 includes such steps as fingerprint acquisition in block 421 and classification and minutiae extraction and enhancement in block 422. Voice enrollment and fingerprint enrollment results are combined into integrated model registration in block 430.

FIG. 4b is a flow diagram of the detailed enrollment module digital speech acquisition steps of block 412 in FIG. 4a, used in speaker voice verification, performed according to the principles of the present invention. The speech acquisition pressure wave is converted to an analog signal by a microphone 430. The analog signal is then improved by passage through an anti-aliasing low-pass filter 440. Finally the conditioned analog signal is sampled and quantized by an analog-to-digital (A/D) converter 450 producing digital speech.

FIG. 4c is a schematic diagram of an exemplary enrollment system used in speaker fingerprint imaging using the principle of frustrated internal reflection (FIR), constructed according to the principles of the present invention. For example, when light from solid state light sources 460 passes from one medium to another (e.g. from air to glass) it is “refracted” or scattered in a predictable way. Light interacting with a glass (or plastic) prism experiences changes in the medium as it enters the prism, as it reaches the air/glass interface at the top of the prism, and finally, as it passes out of the opposite face of the prism.

At each of the discontinuities in the medium, a portion of the light will be scattered (both reflected and bent in a different direction) in accordance with the “refractive index” of the media. In fact, light interacting with the top surface of the prism will normally be totally internally reflected, as if it would when encountering a mirrored surface with the angle of incidence equal to the angle of reflection. However, where fingertip ridge material is brought into contact with the top surface of the prism, there will be a change in the refractive index at that interface, which “frustrates” the light's tendency to reflect, causing much of the incident light to scatter away from the normal angle of reflection.

Live scan imaging systems take advantage of this well-known FIR phenomenon by “viewing” the reflected light from the prism with a solid state CCD imaging camera 480. Wherever the platen surface 470 is clear, CCD camera 480 will see a bright reflection, and wherever the fingerprint ridges 475 are in contact with platen surface 470, CCD camera 480 will see darker areas. The result is that CCD camera 480 “sees” a clear, sharp fingerprint image that looks virtually identical to a fingerprint taken using black printer's ink on a white paper surface. Corrective optics 490 are used to pass the fingerprint images to the DSP 495. An alternative embodiment to DSP 498 uses a hardware chip or a combination hardware/software chip.

FIG. 4d is a flow diagram of the enrollment module feature creation steps used in speaker verification, performed according to the principles of the present invention. The preprocessing of digital speech in block 491 is followed by feature extraction in block 492. The resulting unprocessed feature vectors are subjected to noise compensation and equalization in block 493. Subsequently feature selection in block 494 is performed on the clean feature vectors 495.

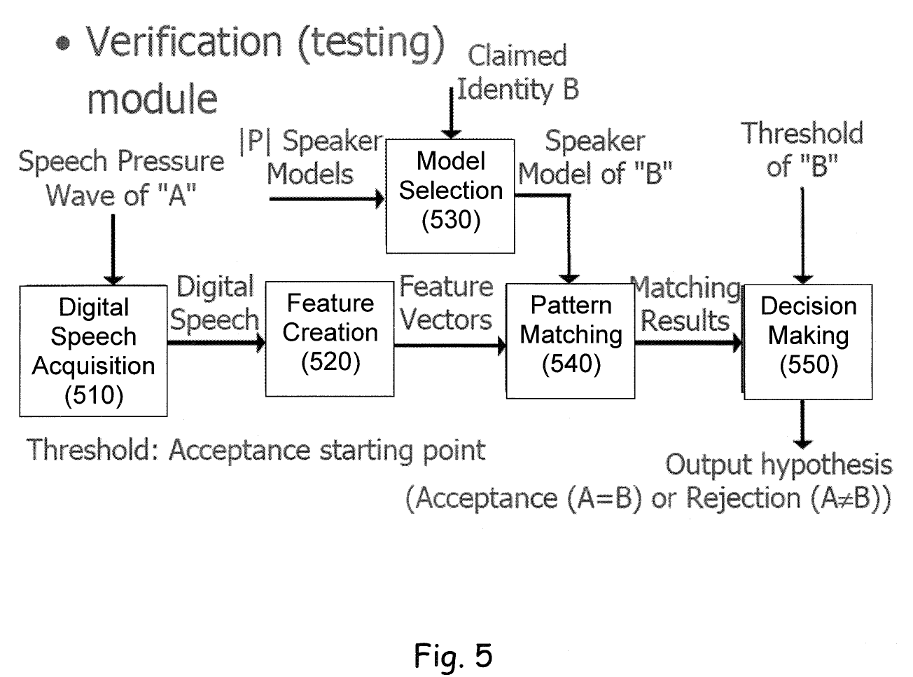

FIG. 5 is a flow diagram of the voice verification steps used in speaker verification, performed according to the principles of the present invention. Digital speech acquisition in block 510 is performed on the utterances of speaker “A.” Feature creation in block 520 is then done on the resultant digital speech patterns further resulting in feature vectors. From a database of speaker models, the claimed identity “B” triggers model selection in block 530 of speaker model of “B,”, which undergoes pattern matching in block 540 against the aforesaid feature vectors. The matching results are checked by decision making 550 against the threshold of “B.” The output hypothesis has a result of acceptance (A=B) or rejection (A≠B), accordingly.

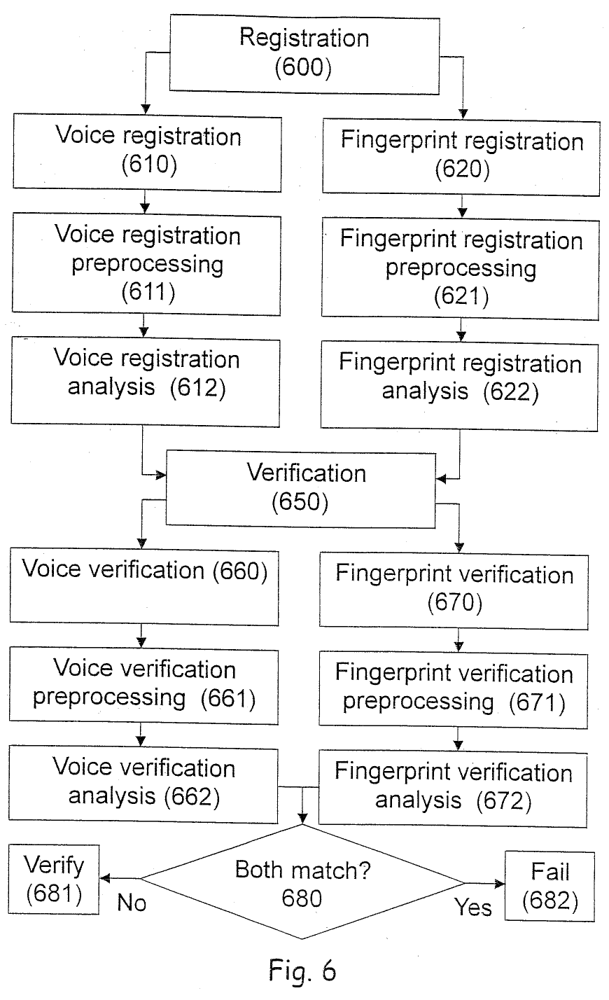

FIG. 6 is a flow chart of the steps used in combining fingerprint verification with voice verification for identity verification, performed according to the principles of the present invention. Registration in block 600 is done for various individuals, as per FIGS. 4a-4d, including voice registration in block 610 and fingerprint registration in block 620. Voice registration in block 610 includes voice registration preprocessing in block 611 and voice registration analysis in block 612. Similarly, fingerprint registration in block 620 includes fingerprint registration preprocessing in block 621 and fingerprint registration analysis in block 622. Subsequent verification in block 650, as per FIG. 5, includes voice verification in block 660 and fingerprint verification in block 670. Voice verification in block 660 includes voice verification preprocessing in block 661 and voice verification analysis in block 662. Similarly, fingerprint verification in block 670 includes fingerprint verification preprocessing in block 671 and fingerprint verification analysis in block 672. When both voice verification in block 660 and fingerprint verification produce a match in block 680 the identity is verified in block 681. If not, the identity check fails in block 682.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A system for verifying and enabling user access based on voice parameters and fingerprint parameters, said system comprising:
a voice registration unit for registering a user by finding the user's voice parameters in a voice registration sample and storing same in a voice sample database to provide a substantially unique and initial identification of each of a plurality of users;
a voice authenticating unit for substantially absolute verification of an identity of one of said plurality of users, said voice authenticating unit comprising:
a recognition unit for providing a voice authentication sample and being operative with said database; and
a decision unit operative with said recognition unit and said voice sample database to decide whether the user associated with said voice authentication sample is the same as the identity of the user registered with the system and associated with said voice registration sample,
a fingerprint registration unit for registering a user by finding the user's fingerprint parameters in a fingerprint registration sample and storing same in a fingerprint sample database to provide a substantially unique and initial identification of each of a plurality of users;
a fingerprint authenticating unit for substantially absolute verification of an identity of one of said plurality of users, said fingerprint authenticating unit comprising:
a recognition unit for providing a fingerprint authentication sample, and being operative with said fingerprint sample database; and
a decision unit operative with said recognition unit and said fingerprint sample database to decide whether the user associated with said fingerprint authentication sample is the same as the identity of the user registered with the system and associated with said fingerprint registration sample,
such that said identity of one of said plurality of users is substantially absolutely verified for access purposes.

2. The system of claim 1, wherein said voice parameters are derived from feature vectors related to physiological aspects of the vocal system of said user.

3. The system of claim 1, wherein said fingerprint registration unit and said fingerprint authenticating unit are installed integrally with said voice registration unit and said voice authentication unit.

4. A method for verifying and enabling access of a plurality of users based on voice parameters and fingerprint parameters, wherein identity verification of a particular user is ultimately based on at least one of voice and fingerprint biometrics of said particular one of said plurality of users.

5. The method of claim 4 comprising:
registering of said parameters of said plurality of users; and
verifying said parameters of a particular one of said plurality of users,
such that access is authorized for said particular one of plurality of users upon successful identity verification.

6. The method of claim 5, wherein said registering comprises voice registration and fingerprint registration.

7. The method of claim 6, wherein said voice registration comprises:
voice registration preprocessing; and
voice registration analyzing.

8. The method of claim 6, wherein said fingerprint registration comprises:
fingerprint registration preprocessing; and
fingerprint registration analyzing.

9. The method of claim 5, wherein said verifying comprises voice verifying for remote access.

10. The method of claim 9, wherein said remote access is conducted over a standard telephone system, and wherein registration and verification of said voice parameters is facilitated by existing standard telephone-based microphones and speakers.

11. The method of claim 9, wherein said remote access is over mobile phone and wherein registration and verification of said voice parameters is facilitated by an existing telephone-based mobile phone microphone and speaker.

12. The method of claim 9, wherein said remote access is over the Internet.

13. The method of claim 5, wherein said verifying comprises fingerprint verifying for proximity access.

14. The method of claim 5, further comprising, as a first step, installing of fingerprint collection equipment.

15. The method of claim 5, wherein said verifying comprises voice and fingerprint verifying for proximity access.

16. The method of claim 4, wherein the access is applied to at least one of the following:
a safe;
a vault; and
a safety deposit box.

17. The method of claim 4, wherein the method is applied in law enforcement for identification from voice samples to enable fraud prevention.

18. The method of claim 4, wherein the method is applied in military decision-making to control activities based on accurate real-time identification of personnel.

19. The method of claim 4, wherein the method is applied to enable access to a facility.

20. The method of claim 4, wherein the method is applied to enable access to a home.

21. The method of claim 4, wherein the method is applied to enable access to an automobile.
